(19) United States
(12) Patent Application Publication
(10) Pub. No.: US 2016/0052121 A1
(43) Pub. Date: Feb. 25, 2016

(54) Hick Carpentry, Construction and Demolition Tool

(71) Applicant: Jahdiel Smith, Grand Prairie, TX (US)

(72) Inventor: Jahdiel Smith, Grand Prairie, TX (US)

(21) Appl. No.: 14/827,208

(22) Filed: Aug. 14, 2015

Related U.S. Application Data
(60) Provisional application No. 62/037,545, filed on Aug. 14, 2014.

(51) Int. Cl. B25F 1/00; B25D 7/00; B25D 1/04; B66F 15/00; B25D 1/06

(52) U.S. Cl. CPC B25F 1/006; B66F 15/00; B25D 1/06; B25D 1/045; B25D 7/00

(57) ABSTRACT

An augmented hammer equipped with a hammer head and pick at one end, and a nail claw and prying claw at the opposite end. The device is further equipped with a fulcrum between the nail claw and the prying claw at the bottom end of the device to give it more leverage when removing nails or when prying objects.

### CLAIM OF PRIORITY

This patent application claims priority under 35 USC 119 (e) (1) from U.S. Provisional Patent Application Ser. No. 62/037,545 filed Aug. 14, 2014, of common inventorship herewith entitled, “Hick Carpentry, Construction and Demolition Tool,” which is incorporated herein by reference as though the same were set forth in its entirety.

### FIELD OF THE INVENTION

The present invention pertains to the field of building, constructing, repairing, and destructing, for professionals and do-it-yourselfers. Field of use includes masonry, roofing, siding, wood framing, cement/concrete repair, board-ups installation/removal, and chiseling.

### BACKGROUND OF THE INVENTION

The prior art has put forth several designs for structural demolition tools. Among these are:

U.S. Pat. No. 8,458,838 to Evers C. Trice describes a multi functional demolition tool including a head assembly having a tip, a plurality of blades, and one or more movable talons. A handle shaft is connected to a head assembly with an actuating mechanism that engages and disengages talons. A handle assembly includes a hammer end and a pry bar end. The demolition tool is useful for firefighters. The tool is used to puncture a ceiling or other structure and remove the ceiling material with the aid of the movable talons. The movable talons automatically disengage if they hit an obstruction. The movable talons are manually disengaged to prevent the tool from getting stuck in the ceiling or other structure.

U.S. Pat. No. 8,117,702 to Joseph Martone, Michael Marusiak, Joseph Martone, Eric Ranieri and Russell Powers describes a demolition tool used in many ways for the demolition of construction materials or other materials. The demolition tool includes a handle having a head at one end. The head has a longitudinal central plane that bisects the head, a strike contact face, and toothed, stepped grasping jaws that accommodate multiple sizes of lumber or other material. The head also includes a blunt blade edge below the strike contact face for striking and demolishing material. The demolition tool includes a bent end pry bar at a second end of the handle. The bent end pry bar is offset approximately ninety degrees from the longitudinal central plane of the tool head enabling full range of motion without interfering with other tool functions. The demolition tool comprises a single piece of material and is softer than tools used to strike it, but harder than materials which it is used to strike.

U.S. Pat. No. 4,034,816 to Louis L. Lutich and Jesse L. Harris describes a projectile type demolition tool. A projectile with an enlarged upper cross sectional area is slideably mounted within and extendable from an inner cylinder. The lower portion of the projectile is extendable through a guide connected to the bottom of the inner cylinder. Upon pressing a working end of the projectile against a work piece to be broken, the projectile recedes upward in the inner cylinder until the enlarged upper area moves above a source of low pressure gas connected through the inner cylinder. The low pressure gas continues to move the projectile upward in the inner cylinder to a cocked position. In the cocked position, a reduced area upper portion of the projectile acts against a moderately high pressure gas injected into a combustion chamber. Thereafter, a high pressure gas is created by an internal combustion in the combustion chamber, which high pressure gas drives the projectile downward into the work piece. During downward movement, the entire upper surface of the projectile is exposed to the high pressure gas. The high pressure gas is exhausted through ports in the inner cylinder into an annulus formed by an outer cylinder, and thereafter through a base support between the outer cylinder and the guide. Any lateral forces that are exerted on the projectile as it breaks the work piece are countered by the cylinders and guide.

None of these prior art references describe the present invention.

### SUMMARY OF THE INVENTION

It is an object of the present invention to provide a specially augmented hammer equipped with a hammer head and pick at one end, along with a nail claw and prying claw at the opposite end. The device is further equipped with a bump or fulcrum at the bottom end of the device to give it more leverage when removing nails or when prying objects.

### BRIEF DESCRIPTION OF THE DRAWINGS

FIG. 1 is an illustrated prototypical top down view of the present invention.

FIG. 1a is a close-up view of an angled head.

FIG. 1b is and a cross sectional cut-away view of the metal T-shaped handle with fiberglass inlay for reinforcement and shock absorption which will also prevent rust and corrosion and lengthen the life of the device.

FIG. 2 is an illustrated prototypical close up view of the hammer head and pick located at one end of the present invention and containing a magnetic core allowing the hammerhead application to hold a broad head nail allowing the user to drive in a single nail with one head because of the 80 degree angled striking surface.

FIG. 3 is a prototypical close up view of the nail and prying claws located at the opposite end of the present invention, further comprising a fulcrum located at the bottom, in the middle, which will allow the user to remove nails or easily pry objects in a confined space.

### DETAILED DESCRIPTION OF THE INVENTION

Every day, thousands of professional contractors and amateur do it yourselfers embark on a variety of construction and home improvement tasks such as building an addition on a home, replacing paneling or flooring, and installing cupboards and countertops. Requiring varying degrees of skill as well as a good eye, the results achieved by successfully completing these tasks are enjoyed for years. Regardless of whether one is a professional contractor or simply a husband and wife duo making improvements to their living space, most people agree that the most important element in the completion of any of these tasks are tools. Whether using pliers to loosen a stubborn screw, a hammer to secure woodwork, a wrench to access a leaky pipe or a screwdriver to assemble an entertainment center, it is essential that an appropriate hand tool is always at the ready whenever a task presents itself. Although collecting an extensive sampling of every hand tool results in one always being prepared, there are drawbacks to such an undertaking. Tools are expensive instruments and stocking one's toolbox quickly turns into a costly process. All the variously sized pliers, wrenches, screwdrivers and wire cutters stored within toolboxes create a sea of clutter that is difficult to manage. Fruitlessly rummaging through a vast array of instruments to find the exact tool turns a potentially satisfying repair job into a daunting and frustrating chore.

The present invention, hereinafter referred to as The Hick Carpentry, Construction and Demolition Tool, or the Hick, is a specially augmented hammer 10 comprising an elongate curvilinear handle 12 equipped with a hammer head pick 20 at its first end, along with a nail claw 24 and prying claw 26 at the second end with a bump 32 at the very bottom to be used as a fulcrum to increase leverage. The Hick 10 provides professionals and do-it-yourselfers with four handy tools in one convenient tool. Fabricated of durable die cast steel, fiberglass and rubber, the present invention includes an elongate handle 12 configured with a visually appealing, ergonomic, curvilinear S shape. The Hick measures approximately eighteen inches in length.

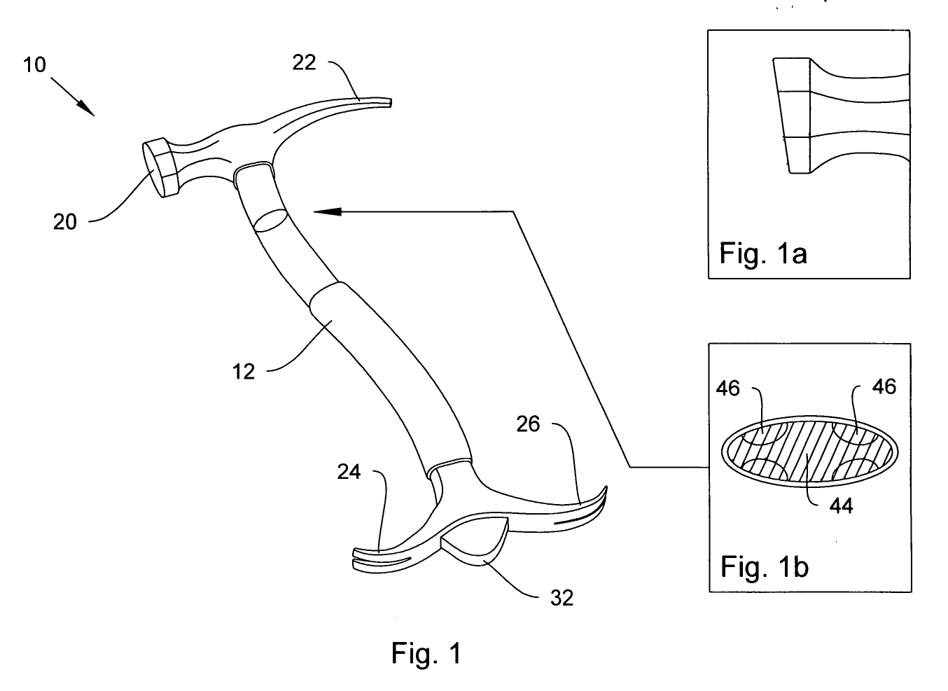

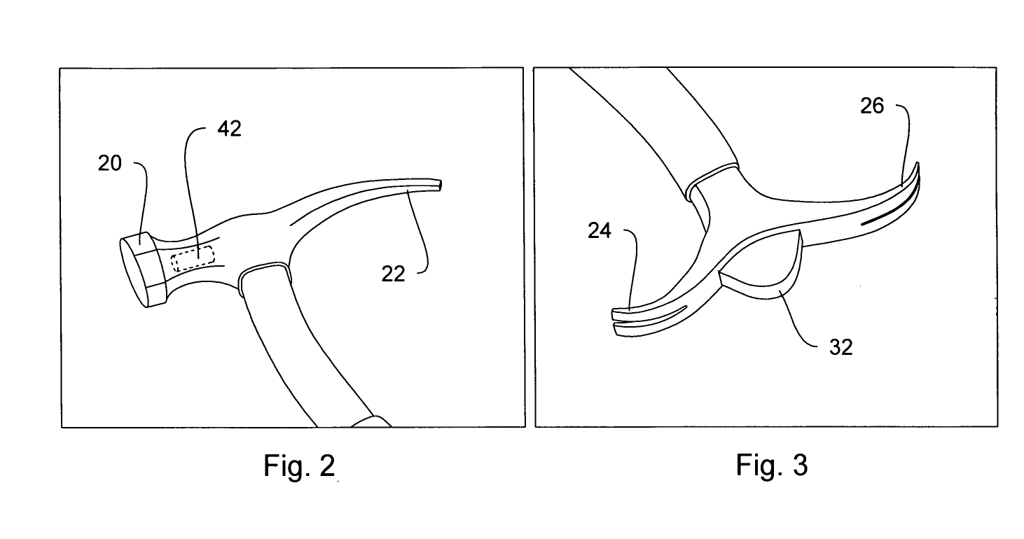

At its first end, the Hick comprises a securely fitted steel instrument that contains a hammer head 20 and a pick 22. Extending forward, the hammer head 20 provides a surface angled at approximately eighty degrees, shown in FIG. 1a. This angle functions as the strike point for affixing a nail head to the hammer's internal magnet 42 which enables a user to hammer in the nail with optimal one handed precision. On the first end, opposite the angled hammer head 20 and extending approximately four inches from the top of the handle, a slightly curved section culminates in a sharp pointed pick 22. This sharp pointed pick 22 functions as a chisel or a pick axe when the need arises. The curvilinear handle 12 is rubber-coated. On the second end, are located dual claws 24, 26 fabricated of steel construction. With each side curving upward, the claw 24 functions as a handy nail removing implement. The Claw 26 functions as a prying claw, perfect for separating boards away from surfaces and similar tasks while utilizing the bump 32 at the bottom of the device to serve as a fulcrum for increased leverage.

Inside the hammer head 20 is a magnetic core 42 to assist in assuring contact at the strike point between the hammer head 20 and a nail or other ferrous fastener.

The curvilinear handle 20 is comprised of a metal or steel central shaft 44 having four fiberglass reinforcement channels along its length. A cross-section of handle 20 is shown in FIG. 1b.

The Hick provides those workers involved in home improvement or construction duties with a simple and effective means of better completing a multitude of tasks with one simple tool. The Hick is a multifunctional instrument comprising a hammer, pick ax, nail claw and pry bar. Easy to use, the versatile present invention completes a multitude of tasks in a matter of minutes. Thanks to its magnetized angled hammer head, broad head nails are masterfully driven without having to use both hands. With a simple twist, the pick chisels through most materials. The nail and prying claws swiftly remove nails or pry away excess materials. Providing quick and efficient operation, this tool is highly functional and effective for anyone involved in construction, repair and demolition activities. Durably constructed, The Hick is instantly mastered by even the most inexperienced handyman and will withstand years of continual wear and use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An elongate tool comprising a hammer head and pick at its first end, and a nail claw and prying claw at its second end, and a fulcrum positioned between the nail claw and the prying claw.

2. The elongate tool of claim 1 further wherein the elongate handle is a curvilinear S-shape.

3. The elongate tool of claim 2, wherein the head of the hammer has an angled striking surface which is approximately eighty degrees from the horizontal plane of the tool.

4. The elongate tool of claim 2, further comprising a magnetic core inserted into the head of the hammer.

5. The elongate tool of claim 2, wherein the curvilinear S-shaped handle comprises a metal central core and four fiberglass reinforcement channels along its length.

6. The elongate tool of claim 2, wherein the curvilinear S-shaped handle is rubber coated.

7. The elongate tool of claim 2, wherein the tool measures approximately eighteen inches in length.
